(19) United States
(12) Patent Application Publication
(10) Pub. No.: US 2020/0319599 A1
(43) Pub. Date: Oct. 8, 2020

(54) DIGITAL FACE-CHANGING WALL CLOCK

(71) Applicant: Jordan STEINBERG, Roslyn Heights, NY (US)

(72) Inventor: Jordan STEINBERG, Roslyn Heights, NY (US)

(21) Appl. No.: 16/838,561

(22) Filed: Apr. 2, 2020

Related U.S. Application Data
(60) Provisional application No. 62/828,188, filed on Apr. 2, 2019.

(51) Int. Cl. G04G 9/00; G09G 5/37; G04G 9/12

(52) U.S. Cl. CPC G04G 9/0005; G09G 2354/00; G04G 9/12; G09G 5/37

(57) ABSTRACT

A clock adapted to be supported by a wall or table includes a central clock face, formed by an LCD screen or the like and controlled electronically to display images. The screen is e controlled by a processing unit receiving signals from a remote device to provide information displaying on the screen the time of day in a format selected by the user as well as information selected by the user to be displayed on the screen. The processing unit contains information to display any of several images to serve as background for the clock face and the processing unit may further be able to receive signals from the remote device to provide information for displaying further images to serve as background for the clock face.

### CROSS-REFERENE TO PRIOR APPLICATION

This application claims priority from provisional application Ser. No. 62/828,188 filed Apr. 2, 2019, the contents of which are incorporated herein by reference.

### FIELD OF THE INVENTION

The present invention relates to a clock, having a digital face that can be changed as desired by the user to provide not only useful information but alternate decorative features.

### BACKGROUND OF THE INVENTION

Various attempts have been made to provide a clock or timepiece, particularly a wall clock, that is not only useful but decorative. Many proposals have been provided, such as described in U.S. Pat. Nos. 5,224,078; 5,787,055; 6,278,664, 6,836,450, 8,480,247 and 8,879,368 to change the decorative features of a clock face. These patents, however, all require cumbersome mechanical aspects to be utilized to change the face of a clock by physically substituting a new decorative clock face.

Other patent documents, such as international application WO 02/37942 describe changing color of a timepiece face electronically, while European patent application EP 2 204 702 describes changing a clock face but not use of an LED screen as the clock face that can generate not only a change in the graphic or decorative design of a clock face but change or select the information displayed as well. U.S. published application 2005/0278757 describes downloading differing watch faces to a mobile watch such as a smart watch; but again not the transmission and display of various types of information on an LED screen that can have the decorative aspects of the clock face changed as well.

The present invention provides a clock with a data processing unit having software enabling multiple functions for the information that can be displayed by the clock and access by the user to a network to transmit information from the user. In this way, the user is able to set certain formats for the face of the clock, including the selection of decorative backgrounds for the face of the clock, and to choose the information displayed by the clock, such as the indoor or outdoor temperature, or even display calendar events or other information, all by a mobile device connected to the internet.

Many consumers buy a wall clock that fits their decorative taste or room decor. By the present invention, an improved clock is provided having a face that can be changed by the user to select various decorative qualities, but also provide useful information; all controlled by the user from a mobile device. The present invention allows the user to easily change the look of the face of the clock to conform with any changes in decor made by the consumer; as well as provide useful information beyond the time of day. And all easily controlled by the user with a laptop or mobile device connected to an online network.

### SUMMARY OF THE INVENTION

A digital decor clock adapted to be mounted to a surface, such as the wall in a user's home, or placed on a horizontal surface, such as a night table, has a traditional border and an LCD screen as the face of the clock. The clock includes a data processing unit suitably programmed to provide images on the LCD screen. The data processing unit is controlled by a specific application (app) that can be downloaded into a computer of the user, or more preferably, to a mobile device under the control of the user. The app controls the data processing unit which has software enabling multiple functions to be selected for the clock by the user accessing a network to transmit information from the user. In this way, the user is able to set by a mobile device or computer connected to the internet certain formats for the face of the clock, including the selection of decorative backgrounds for the face of the clock, and to choose the information displayed by the clock, such as the indoor or outdoor temperature, or even display calendar events or other information desired by the user.

These and other objects, features and advantages of the present invention will be come apparent foe a review of the following detailed description made in conjunction with the following drawings:

### BRIEF DESCRIPTION OF THE DRAWINGS

FIG. 1A illustrates a clock of the present invention with traditional hands;

FIG. 1B illustrates a clock of the present invention with the hands displayed by an image created on the LED screen;

FIG. 2 illustrates various clock faces of the present invention;

FIG. 3 illustrates another clock face of the present invention;

FIG. 4 represents the back of the clock of the present invention;

FIG. 5 represents a mobile device that can be used in conjunction with the present invention.

### DETAILED DESCRIPTION OF A PREFERRED EMBODIMENT

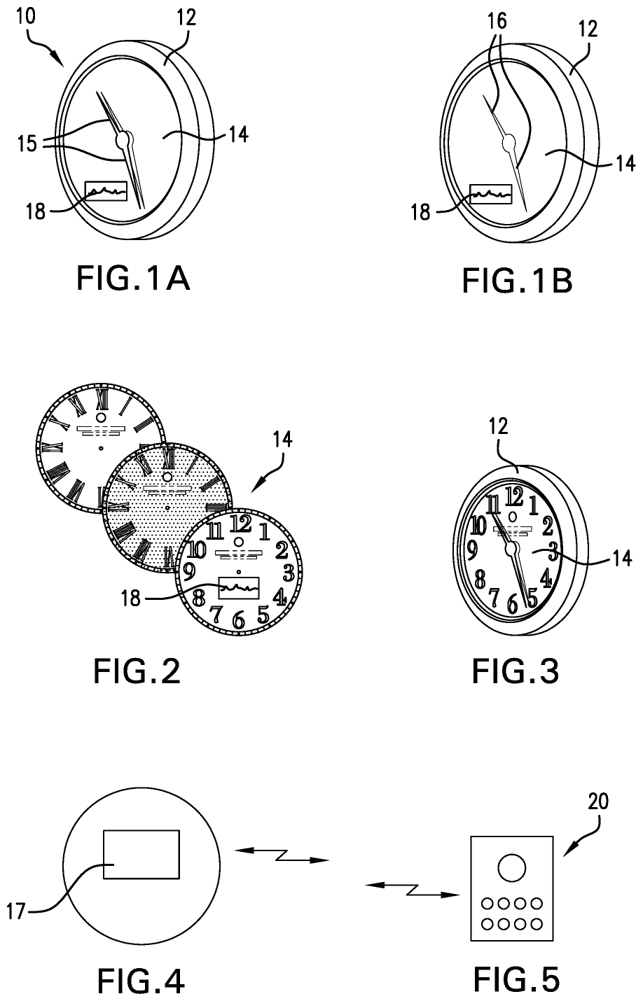

The clock 10 of the present invention includes a traditional border 12 surrounding an LED screen 14 serving as the clock face. As shown in FIG. 1A, the hands 15 of the clock are the typical mechanical hands controlled to rotate in the normal fashion; and as shown in FIG. 1B, the hands could be digital representations 16 formed as an image on the LCD screen 14 by the processing unit 17 located on the rear of the clock as illustrated in FIG. 4.

The LCD screen can also have a data section 18, that can display information requested to be displayed by the user. Such information could, for example, be the temperature either inside a building or immediately outside; calendar events for the day or other information as desired.

Inasmuch as the LED screen 14 is controlled by the processing unit 17, any type of information requested by the user could be displayed. The user can download an app to enable use by a mobile device 20 to transmit data and instructions to control the processing unit 17 by known techniques through an online network.

The processing unit has digital images stored within to generate the decorative features and aspects of the clock that will be displayed on the LCD screen 14. Photographs can be taken by any electronic hand-held device such as the mobile device 20, and uploaded as desired to the processing unit 17; or digital images can be pre-programmed for the clock 10 and selected by the user or stored or downloaded to any electronic hand-held device such as the mobile device 20, and uploaded as desired to the processing unit 17 of the clock 10. In this way, digital images can be stored in the program for the clock that the user acquires with the clock, or digital images acquired by the consumer can be uploaded to be presented as the face of the clock as desired.

In this way, the decorative features of the clock face can be changed, differing script can be used for the traditional numerals of the clock; or Roman numerals as desired. The decorative background of the clock can be changed at will; and even set to rotate images as well known for digital picture frames. Differing information can be displayed in the data section 18, including appointments for the day, weather predictions for the day or even such items as an unanswered call had been received by the mobile device.

In this way, the household clock becomes not only a decorative item that can be changed as desired; but a convenient conveyer of useful information.

These and other objects, features and advantages of the present invention will be apparent to one skilled in the field; and my invention is defined by the appended claims.

What is claimed is:

1. A clock adapted to be supported by a surface so as to be visible to a user and including a border surrounding a clock face, said clock face being formed by a screen controlled electronically to display images, said screen adapted to be controlled by a processing unit adapted to receive signals from a remote device to provide information displaying on said screen the time of day in a format selected by the user, said processing unit further able to receive signals from the remote device to provide information selected by the user on said screen, said processing unit containing information to display any of several images to serve as background for said clock face.

2. A clock as set forth in claim 1, said processing unit further able to receive signals from the remote device to provide information for displaying further images to serve as background for said clock face.
